(19) United States
(12) Patent Application Publication
(10) Pub. No.: US 2016/0025591 A1
(43) Pub. Date: Jan. 28, 2016

(54) AUTOMATED DEFLECTOMETRY SYSTEM FOR ASSESSING REFLECTOR QUALITY

(71) Applicant: esolar Inc., Burbank, CA (US)

(72) Inventors: Jeremy Risner, Port Clinton, OH (US); Maximilian Zavodny, Pasadena, CA (US)

(73) Assignee: ESOLAR INC., Burbank, CA (US)

(21) Appl. No.: 14/806,627

(22) Filed: Jul. 22, 2015

Related U.S. Application Data
(60) Provisional application No. 62/027,746, filed on Jul. 22, 2014.

(51) Int. Cl. G01M 11/00; G06T 7/00; G06T 7/60; G06K 9/62; G06T 7/40; G06K 9/46; H04N 17/00; G01B 11/24; G06K 9/52

(52) U.S. Cl. CPC G01M 11/005; G01B 11/24; G06T 7/0004; G06T 7/60; G06K 9/52; G06T 7/408; G06K 9/4652; H04N 17/002; G06K 9/6201; G06K 9/6267; G06T 7/001; G06K 9/4604; G06T 2207/30108

(57) ABSTRACT

An automated deflectometry system and method for assessing the quality of a reflective surface for use in a concentrating solar power plant. The deflectometry system comprises a holding fixture for mounting a heliostat reflector opposite a target screen having a known pattern. Digital cameras embedded in the target screen take pictures of the known pattern as reflected in the surface of the reflector. Image processing software then detects the features of the pattern in the reflector images and calculates the slope profile of the reflective surface. The slope field can be calculated by comparing the images of the reflective surface to those of a reference surface. Based on the slope profile of the reflective surface, a ray tracing calculation can be performed to simulate flux as reflected from the reflective surface onto a receiver and a quality metric can be ascribed to the heliostat reflector. The result of the quality assessment can displayed using a graphical user interface on an automated assembly line.

### CROSS-REFERENCES TO RELATED APPLICATIONS

The present application claims priority to and the benefit of U.S. Provisional Patent Application No. 62/027,746, filed on Jul. 22, 2014, the entire disclosure of which is incorporated herein by reference.

### BACKGROUND OF THE INVENTION

This disclosure relates generally to an apparatus and method for assessing the quality of a reflector. In particular, the invention relates to an improved deflectometry system for measuring the slope of a reflective surface and predicting its performance as part of a solar-collecting heliostat field.

In Concentrating Solar Power (CSP) plants an array of heliostats reflect sunlight toward a receiver mounted atop a central tower and containing a working fluid. One type of receiver transfers incident radiant energy to the working fluid to produce output high-pressure, high-temperature steam, which can later be fed to a turbine for electrical power generation. Heliostats are generally mounted on the ground in an area facing or surrounding the tower. Each heliostat has a reflector: a rigid reflective surface such as a mirror that tracks the sun through the actuation of a heliostat drive mechanism about at least one axis. Sun-tracking involves orienting the reflector throughout the day so as to optimally redirect sunlight from the sun toward the receiver and maintain the desired temperature of the working fluid.

The performance of reflectors in CSP systems is highly dependent on their shape and curvature. Large variations from a desired surface profile (e.g. flat or curved)slope amongst many reflectors in a field can hinder the supply of requisite flux to the receiver, as the amount of light reflected from the heliostats may not comply with expected results garnered from simulations and calculations by plant operators. Adherence to an intended shape is therefore a concern during the reflector assembly process.

Conventional techniques for measuring the curvature and surface quality of a mirror include Deflectometry, Interferometry, Photogrammetry, and Video Scanning. In deflectometry a digital camera is used to take a photograph of an image reflected in a surface to-be-measured. The image is typically a repeated pattern, such as a checkerboard. Software is then employed to discern variances between the image reflected in the target reflector and the image reflected in a reference surface. Photogrammetry involves attaching retro-reflective tags or stickers to an object surface and taking multiple photos of said surface using at least one camera, followed by quantitative analysis of mapping between the photographs. Interferometry is the process of measuring differences in surface height along the plane of a reflector by superimposing reflected light waves from a Helium-Neon laser. In the video scanning method (such as VSHOT, the Video Scanning Hartmann Optical Test), a direct measurement of surface slope variance can be obtained by reflecting a laser off a reflector to the aperture of a digital camera. Of these methods, deflectometry is the most well suited for quality control in an industrial assembly line due to the speed at which measurements can be taken (only one photo from each camera is required), minimal RMS error (high resolution digital cameras can ascertain minute variances between images), and the comparatively lower cost of the system hardware (no lasers required).

Even amongst deflectometry solutions there exist drawbacks that hinder its use as a quality checking system in high-volume manufacturing. Determining the slope map of a reflective surface can be a timely calculation, and there is often no correlation made between the curvature of the reflector and its effects on in-field performance. Because the slope calculations are dependent on precise positioning of the camera and the light source with respect to the reflector, the physical system is sensitive to even small perturbations and disturbances common in an assembly environment, requiring well-surveyed, configured, and calibrated components. Finally, conventional deflectometer techniques do not possess the capability to unambiguously identify specific features in a reflected pattern if the pattern comprises repeated sections. There exists a need for a more robust deflectometry system that can quickly and accurately take measurements of reflector surfaces for quality control in an assembly process.

### SUMMARY OF THE INVENTION

An improved quality assessment method and apparatus for the automated assembly of reflectors is described herein, wherein the quality assessment system comprises a deflectometer apparatus and image processing software that can determine the slope profile of the reflector and predict its performance in a concentrating solar field. By incorporating improved algorithms for calibrating the apparatus setup and identifying specific features in a reflected pattern, the proposed system advantageously increases the speed at which measurements can be taken while minimizing the susceptibility of the system to physical disturbances.

The deflectometer apparatus comprises two or more digital cameras having a high resolution and a narrow field of view, a target comprising a flat panel imprinted with a known pattern, a holding fixture upon which a reflector (to-be-measured) is mounted, a calibration surface having a known or unknown shape and slope profile, and a console having a user interface through which the apparatus can be operated and images and data can be viewed. The holding fixture can be a free-standing structure or an articulating robot. The image processing software takes as an input the images taken by the digital cameras of the known pattern reflected in the reflector and calculates a slope profile of the mirror, wherein the slope profile is a map of the angular direction of reflected light from multiple points on the surface. For example, the image processing software can compare the location of features in the reflected image with features in the image of a calibration surface. Deviations between the pattern as reflected in the reflector under scrutiny and the pattern as reflected in a calibration surface can used to determine a slope profile for the reflector being measured. Other means of determining the slope profile of a reflector can include direct measurements of incident light angles from a single or composite image, or the differential reconstruction of multiple images of the same surface taken in different positions. Differential reconstruction is the process of generating a slope profile of a two-dimensional surface from a gradient field; in the present application that gradient field is found by differentiating between first and second images of a reflected pattern, wherein each image captures the pattern in a different position relative to the camera. This slope profile can be utilized to predict the performance of the reflector in a solar field; the results of said prediction help determine whether the reflector meets predetermined metrics for quality assurance.

A method of assessing reflector quality can comprise the following three Phases: Commissioning, Calibration, and Data Collection/Analysis. In the Commissioning Phase, the digital cameras are positioned and zoomed, and focused to effectively and clearly capture the space in which the reflector will be located. Additionally the system geometry (e.g. the spatial dimensions of the reflector and its orientation relative to the target screen and features in the pattern) can be measured and adjusted.

In the Calibration Phase, a calibration surface is placed in the same plane within which the reflector-to-be-measured will be positioned and is mounted to the holding fixture. Images are then collected of the calibration surface by all cameras and the image processing software locates the features of the known pattern and ascribes coordinates to those locations in the image. Images of reflective surfaces measured by the deflectometry apparatus after the Calibration Phase are compared to the images of the calibration surface to establish deviation from a reference surface. Comparing reflective surfaces to a reference surface improves the speed by which the quality assessment system can analyze a large population of units, since the calibration step need only be performed once prior to measuring a plurality of reflectors. The present invention discloses multiple means for establishing this reference surface.

According to a first embodiment of the method for assessing reflector quality, the Calibration Phase comprises the steps of:

mounting a calibration surface having a known slope profile to a stationary holding fixture in a plane parallel to the target screen, wherein the calibration surface has a larger mirror area than the mirror area of the reflective surface to-be-measured,

overlaying a template having the same dimensions as the reflective surface to-be-measured onto the calibration surface,

taking images of the calibration surface using the digital cameras,

determining the coordinates of the corners of the template using the image processing software, and

locating the features of the known pattern as reflected in the calibration surface.

Because the calibration surface can be fabricated to as close to an ideal quality as possible at a size large enough to reflect the entirety of the target screen, the system according to the first embodiment does not require an actuating holding fixture with moving parts.

According to a second embodiment of the method for assessing reflector quality, the Calibration Phase comprises the steps of:

mounting a calibration surface having an unknown slope profile to a movable holding fixture in a plane parallel to the target screen, wherein the calibration surface has a larger mirror area than the mirror area of the reflective surface to-be-measured,

overlaying a template onto the calibration surface,

translating the holding fixture in the plane parallel to the target screen along a first axis and taking an image of the shifted calibration surface,

translating the holding fixture in the plan parallel to the target screen along a second axis and taking an image of the shifted calibration surface,

performing a differential reconstruction of the images,

determining the coordinates of the corners of the template, and

locating the features of the known pattern as reflected in the differentially reconstructed image of the target screen as reflected in the calibration surface.

The method of differential reconstruction can supply a reference image from a surface without knowing the curvature or slope profile ahead of time. The result is that the system according to the second embodiment does not require a calibration surface fabricated under strict tolerances and can be used with a plurality of calibration surfaces.

According to a third embodiment of the method for assessing reflector quality, the Calibration Phase comprises the steps of:

mounting a calibration surface having an known slope profile to a movable holding fixture in a plane parallel to the target screen, wherein the calibration surface has a substantially smaller mirror area than the mirror area of the reflective surface to-be-measured,

repeating, at least twice, the step of translating the holding fixture in the plane parallel to the target screen and taking an image of the shifted calibration surface,

stitching the plurality of images together into a composite, and

locating the features of the known pattern as reflected in the composite image of the target screen as reflected in the calibration surface.

Because a smaller calibration surface is easier to fabricate under rigid tolerances for slope profile and curvature, the system according to the third embodiment can lower production costs when compared to the first embodiment.

In the Data Collection/Analysis Phase a reflector to-be-measured is mounted to the holding fixture in the field of view of the cameras and opposite the target having the known pattern. Images of the reflector are then collected by all cameras and provided as inputs to the image processing software. The image processing software immediately operates to locate features of the known pattern in the image and compares the locations of the features to corresponding locations found in the image of the calibration surface taken during the Calibration Phase. The software then calculates the slope profile of the reflector. The software can also perform a ray-tracing calculation to predict the performance of the reflector as if it were placed in various positions within a concentrating solar field. The software can also provide the RMS slope error between the slope profile and a reference or desired profile. Any or all of the software outputs can be supplied to the display of a console having a user interface, wherein an operator can make an informed determination as to the quality of the reflector. Alternatively, quality determination of the reflector can be automated by prescribing a threshold by which the slope profile or other performance metric is deemed acceptable. The deflectometer system and method therefore can be applied as a quality check in an automated assembly line for heliostat reflectors.

According to a fourth embodiment, the method of assessing reflector quality comprises only a Commissioning Phase and a Data Collection Phase and obviates the need for a calibration surface or a Calibration Phase. This method comprises the following:

A Commissioning Phase comprising the steps of:

positioning and orienting the digital cameras to have a sufficient field of view to encompass the volume of a holding fixture and reflector,

approximating the geometry of the system, and

mounting the reflector-to-be-measured onto a movable holding fixture in a plane parallel to the target screen, and

a Data Collection Phase comprising the steps of:

translating the holding fixture in the plane parallel to the target screen along a first axis and taking an image of the shifted calibration surface,

translating the holding fixture in the plan parallel to the target screen along a second axis and taking an image of the shifted calibration surface,

performing a differential reconstruction of the images,

determining the coordinates of the corners of the reflective surface, and

locating the features of the known pattern as reflected in the differentially reconstructed image of the target screen as reflected in the reflective surface.

Because the method of differential image reconstruction is used on each measured reflector individually, the system according to the fourth embodiment does not require a calibration surface or a surface specially fabricated to have an ideal slope profile.

### BRIEF DESCRIPTION OF THE DRAWINGS

FIG. 1 illustrates a first embodiment of the reflector quality assessment apparatus in operation, wherein the holding fixture is a free-standing structure.

FIG. 2 illustrates an alternative embodiment of the reflector quality assessment apparatus in operation, wherein the holding fixture is a robot having an articulating arm.

FIG. 3 is a top view of the reflector quality assessment apparatus and the requisite relative spacing of the individual components.

FIGS. 4A-4D illustrate ray trace vectors from the reflection of the target to imaging cameras positioned in a left/right orientation.

FIGS. 5A-5D illustrate ray trace vectors from the reflection of the target to imaging cameras positioned in a top/bottom orientation.

FIG. 6 illustrates an example of a known pattern as affixed to a target, wherein the known pattern exhibits various features for ease in calibration and measurement.

FIG. 7 is a flowchart diagram depicting a method for assessing the quality of a reflective surface with use of an embodiment of the present invention.

FIG. 8 is a flowchart diagram depicting the Commissioning Phase of the method of assessing reflector quality.

FIG. 9 is a flowchart diagram depicting the Calibration Phase of the method of assessing reflector quality.

FIG. 10 is a flowchart diagram depicting the Data Collection/Analysis Phase of the method of assessing reflector quality.

FIG. 11 is a depiction of simulated flux from a reflector onto a receiver and the boundary by which a characteristic beam metric is determined.

### DETAILED DESCRIPTION OF THE PREFERRED EMBODIMENTS

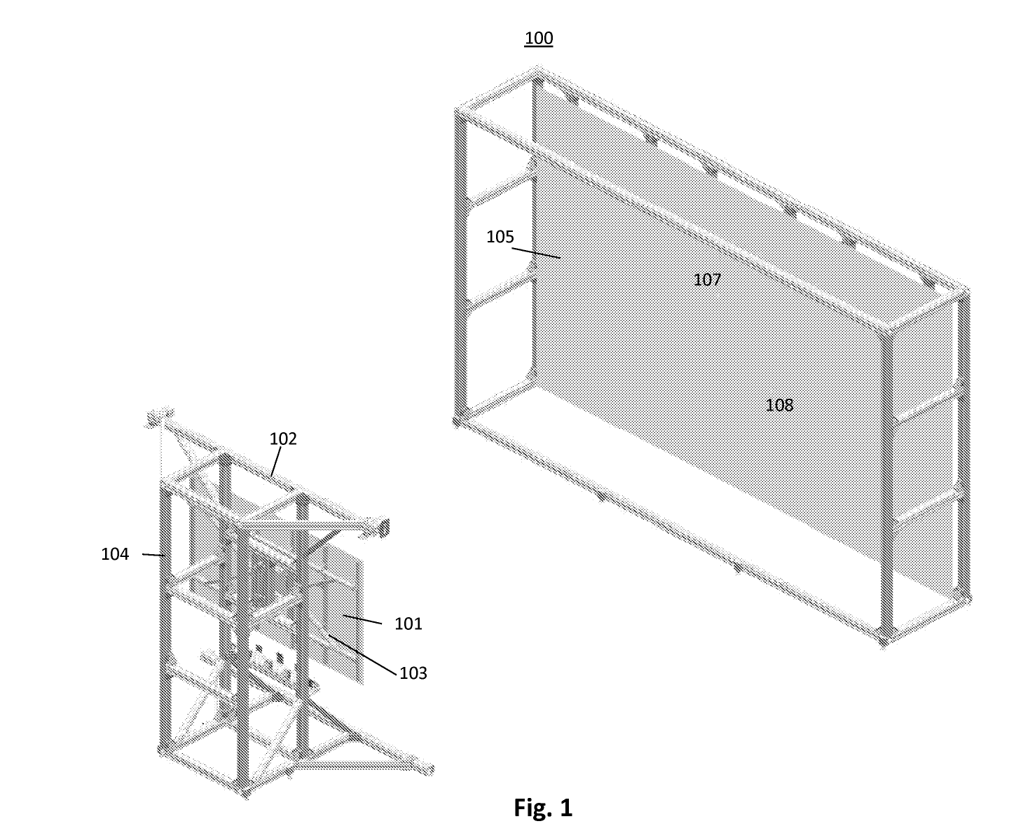

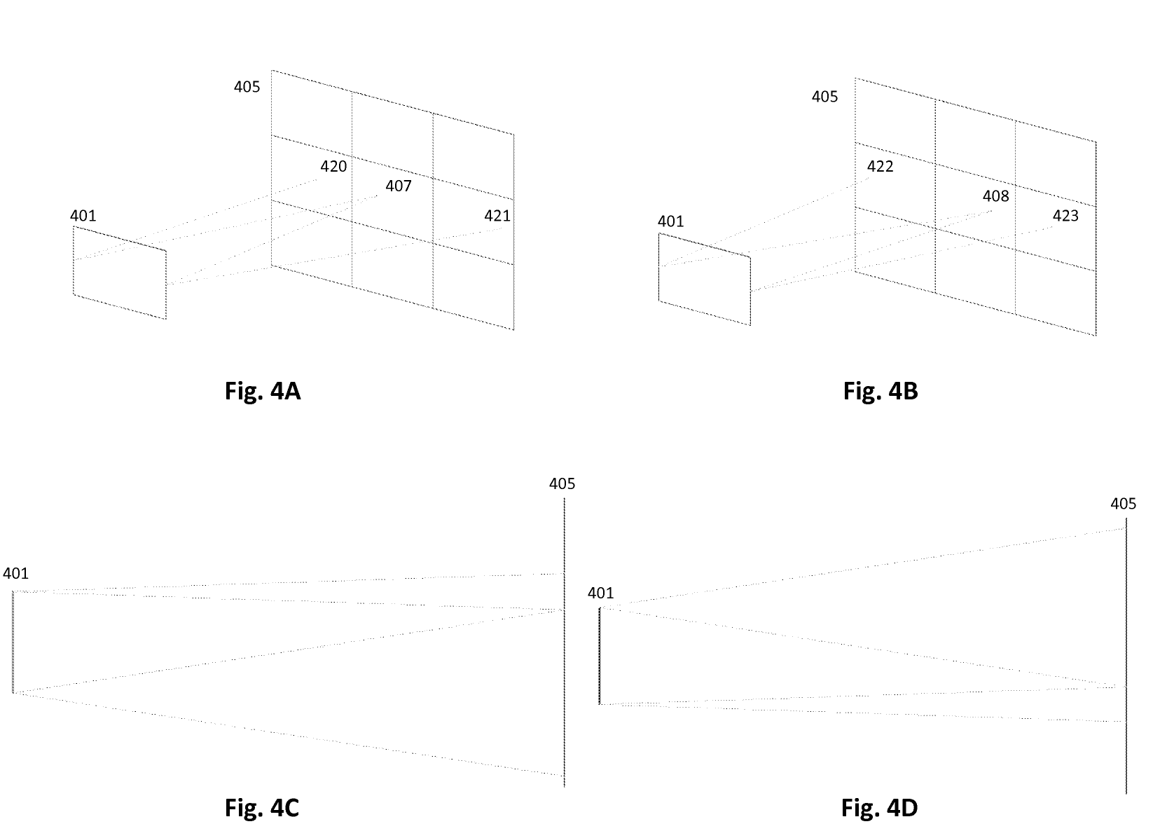

An improved quality assessment apparatus for the automated assembly of reflectors is further described herein with reference to FIGS. 1-3. A method for assessing the quality of a reflector is further described with reference to FIGS. 4-7.

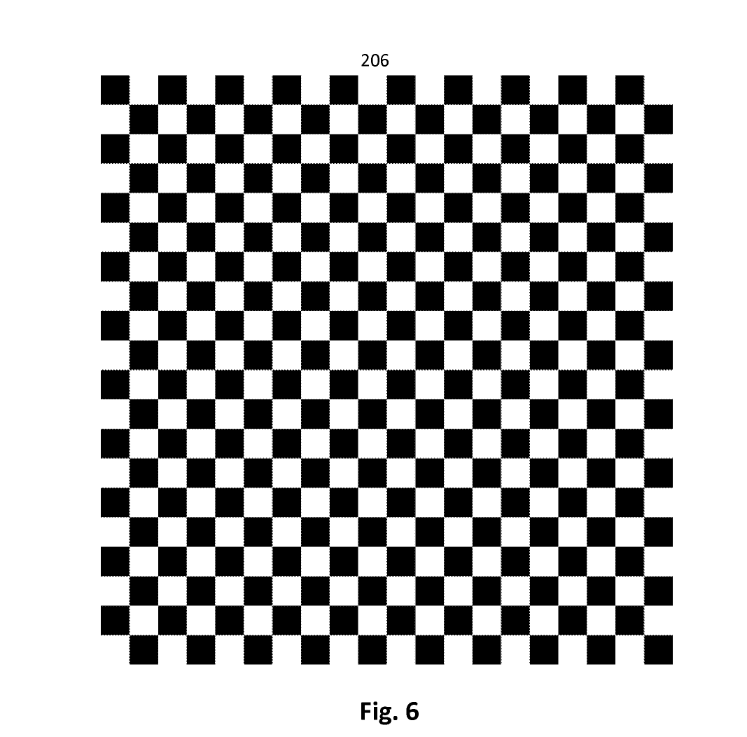

FIG. 1 depicts an embodiment of the quality assessment apparatus setup for calibration. The apparatus 100 comprises a calibration surface 101 mounted to a holding fixture 102. The calibration surface is formed from a reflective material, such as a glass mirror, that can be attached to a frame 103. The frame can be made integral with a mounting bracket 104. The mounting bracket interfaces with holding fixture 102 to maintain the position of the calibration surface opposite a target screen 105. In order to reflect the largest possible image at a distance the target screen is formed to be at least twice the area of the reflector. The holding fixture 102 is a free-standing structure supported by legs or cross-bracings and made integral with a base. The holding fixture can be made of a suitably rigid material such as aluminum. The target screen 105 is overlaid with a known pattern 106 (not shown, see FIG. 6) made integral with the target screen or attached thereupon. The known pattern can be a repeating grid such as a checkerboard or a sequence of colored shapes. Cameras 107 and 108 are positioned within holes in the target screen surface such that their lens apertures face the calibration surface 101. In an alternative embodiment (not shown), the calibration surface can be hung from the holding fixture without being attached to a frame.

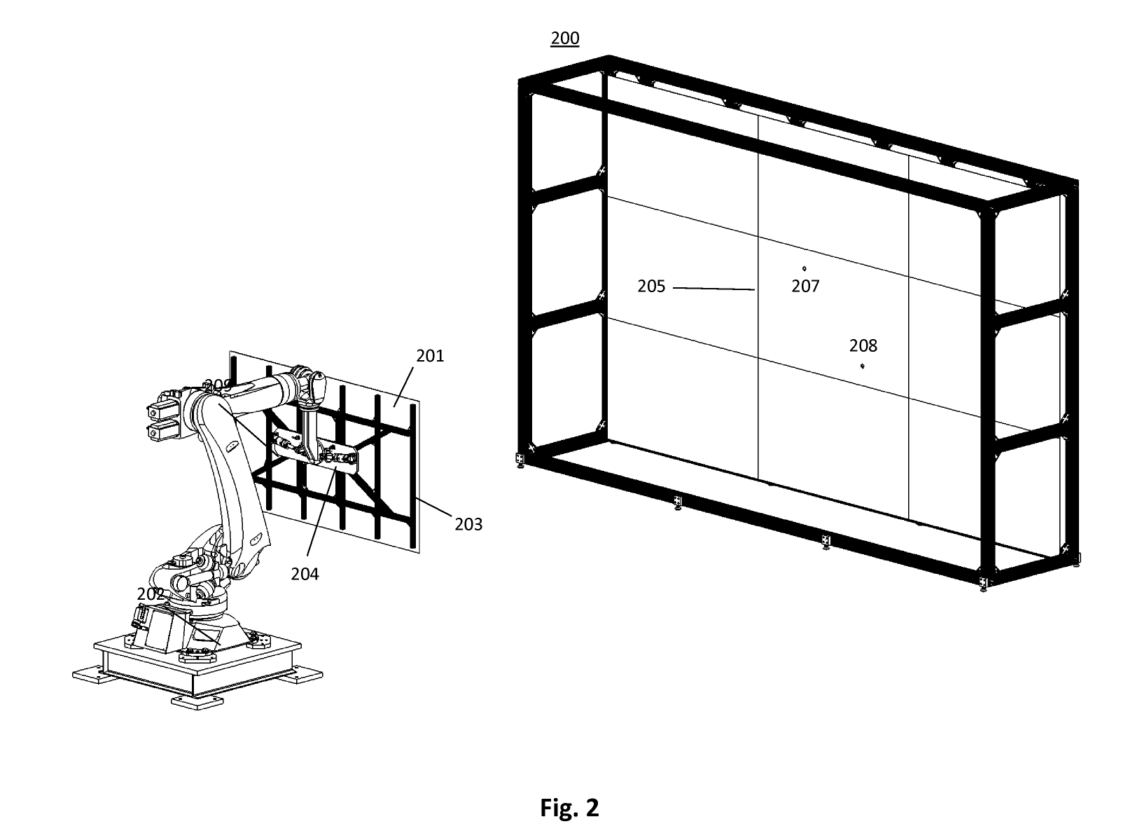

FIG. 2 depicts an additional embodiment of the quality assessment apparatus setup for calibration. Unlike the previous embodiment, the present apparatus 200 comprises as the holding fixture 202 a robot having an articulating arm capable of translating the calibration surface 201 along both axes in the plane of the reflective surface. The calibration surface is mounted to frame 203 made integral with a mounting bracket 204. The mounting bracket interfaces with the articulating arm 209 of the holding fixture 202 allowing the robot to hold the position of the calibration surface opposite a target screen 205 or to translate the calibration surface in a plane parallel to the target surface. The holding fixture robot 202 can be mounted on a stationary platform and can be manually controlled or set to operate automatically. In order to reflect the largest possible image at a distance the target screen is formed to be at least twice the area of the reflector. The target screen 205 is overlaid with a known pattern 206 (not shown, see FIG. 6) made integral with the target screen or attached thereupon. The known pattern can be a repeating grid such as a checkerboard or a sequence of colored shapes. Cameras 207 and 208 are positioned within holes in the target screen surface such that their lens apertures face the calibration surface 201. In an alternative embodiment (not shown), the calibration surface can be hung from the holding fixture without being attached to a frame.

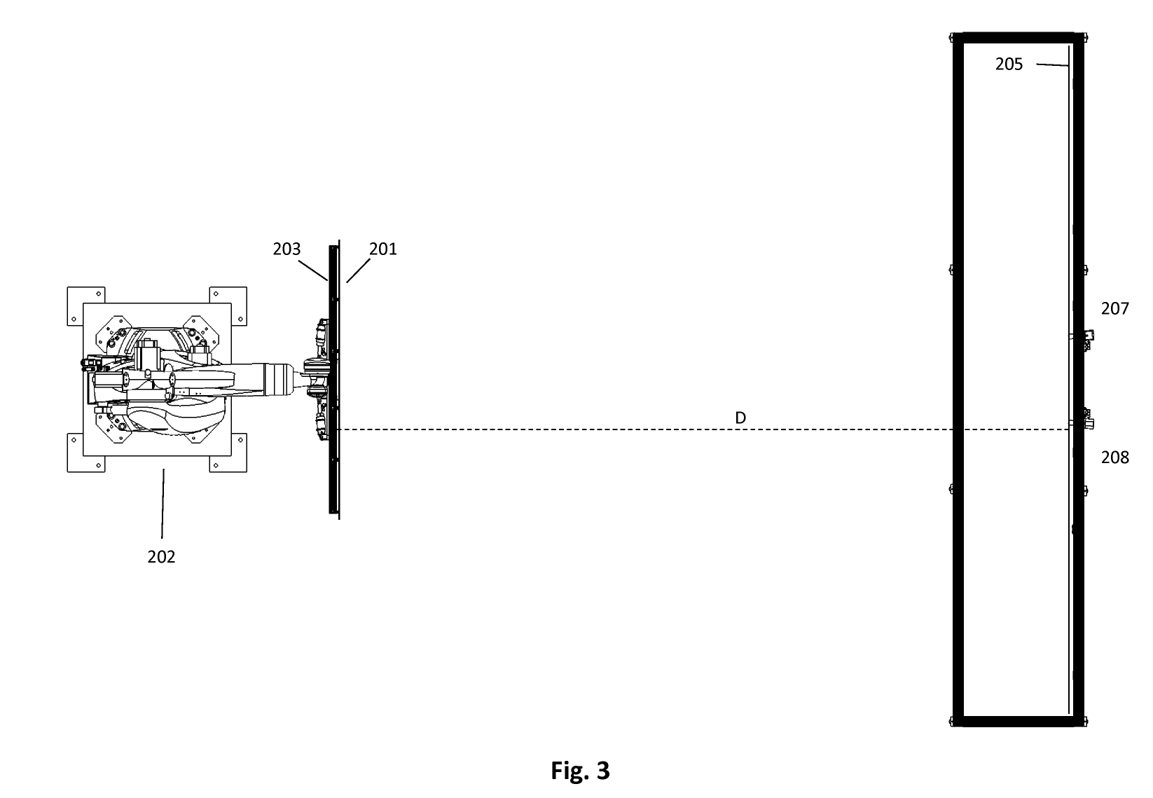

FIG. 3 is a top down view of the embodiment according to FIG. 2 establishing the optimal spacing of the target screen 205 from the holding fixture 202. Cameras 207 and 208 are positioned to each possess a field of view covering a 45 degree arc from the lens aperture. This can be accomplished by positioning each camera at opposite corners of a square region encompassing the center of the target screen 205 or by positioning each camera at the midpoints of opposite sides of said square region. The target screen 205 is set opposite the calibration surface 201 such that each of the two cameras 207 and 208 has a field of view that encompasses the entirety of the target screen and the known pattern (not visible). This distance D between the calibration surface and the target screen is selected to minimize error in the image processing calculation. The closer the plane of the reflective surface is to the plane of the target screen, the more the target screen image will fill the mirror area. This will result in the pixels of the camera images encompassing greater segments of the reflected image, exacerbating the effects of error or distortion. For example, slight variations in the parallelism of the reflector frame and the holding fixture position can introduce error into the slope profile, because the angle of reflection is not being measured from a surface parallel to the target screen and the cameras. The further the holding fixture and reflector are positioned from the target screen, the less such error is exhibited in the results.

FIGS. 4A through 4D depict ray trace lines from points on the target screen surface reflected in the calibration or reflector surface to digital cameras embedded in the surface of the target screen at points proximate the left and right of a central region. As described previously, the target screen pattern is reflected in the calibration surface or reflector surface to-be-measured. From two given points 420 and 421 located on the target a ray can be drawn from the target screen 405 to the reflective surface 401 and reflected back to the lens of a first digital camera 407. Likewise, from two given points 422 and 423 on the target a ray can be drawn from the target screen to the reflective surface and reflected back to the lens of a second digital camera 408.

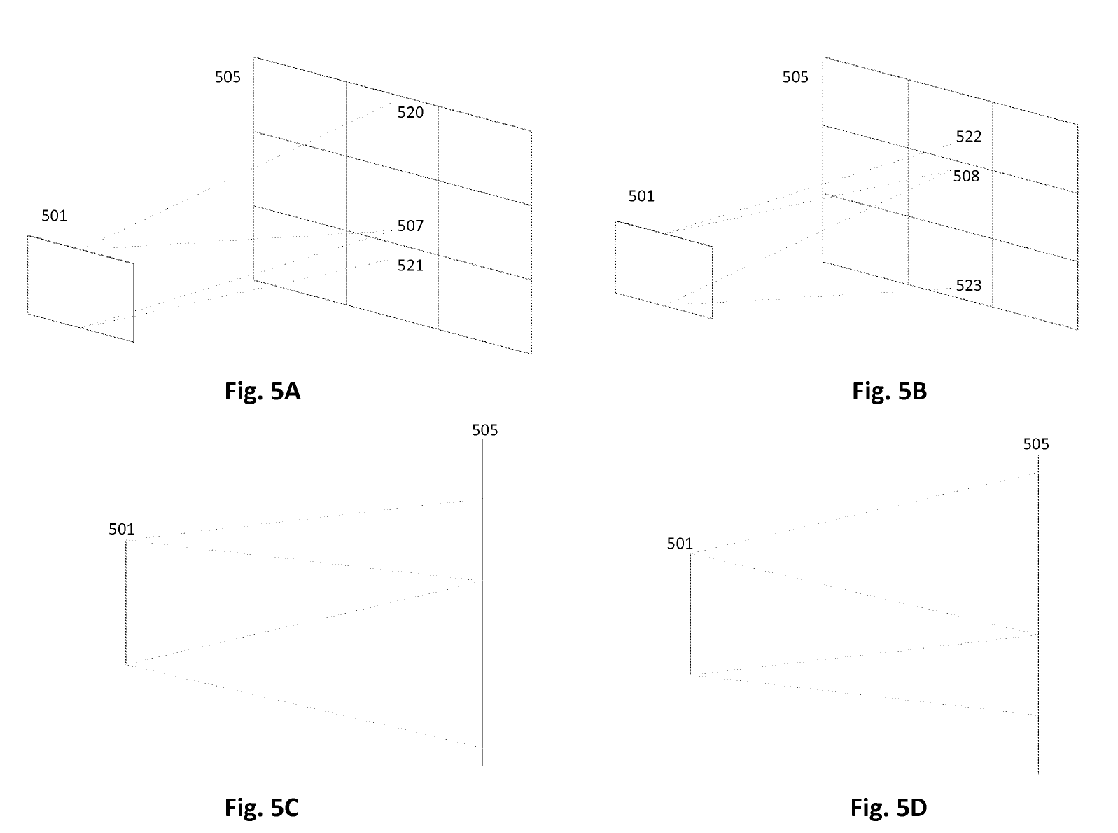

FIGS. 5A through 5D depict ray trace lines from points on the target surface reflected in the calibration or reflector surface to digital cameras embedded in the surface of the target screen at points proximate the top and bottom of a central region. The target screen pattern is reflected in the calibration surface or reflector surface to-be-measured. From two given points 520 and 521 located on the target a ray can be drawn from the target screen 505 to the reflective surface 501 and reflected back to the lens of a first digital camera 507. Likewise, from two given points 522 and 523 on the target a ray can be drawn from the target screen to the reflective surface and reflected back to the lens of a second digital camera 508.

FIG. 6 is an example of a known pattern 206 used on the target screen for reflection onto the calibration and reflector surfaces. The known pattern is selected for having features that are quick and easy to identify through conventional computer vision techniques and commercially available, non cost-prohibitive camera systems. An exemplary example is a repeating pattern of alternating black and white squares, akin to the layout of a checkerboard. Alternatives for the pattern can include alternating black and white symbols having other shapes, such as circles, or gridlines having variable thickness and spacing. The target having the known pattern must be large enough such that every point in the reflective or calibration surface can reflect a point on the pattern within the field of view of all digital cameras. For this reason an exemplary size for the target is at least twice as large in both height and width as the corresponding dimensions of the calibration surface. The known pattern further comprises at least one feature that is immediately noticeable as being markedly distinct from the general pattern; this is hereafter referred to as the “non-repeating” feature. Such a feature can break the cyclic ambiguity presented by identical tessellated features and improves the ability of the image processing software to uniquely identify a feature on the known pattern. An exemplary example of a non-repeating feature is a non-white spot or symbol located in the center of one of the white squares of the checkerboard.

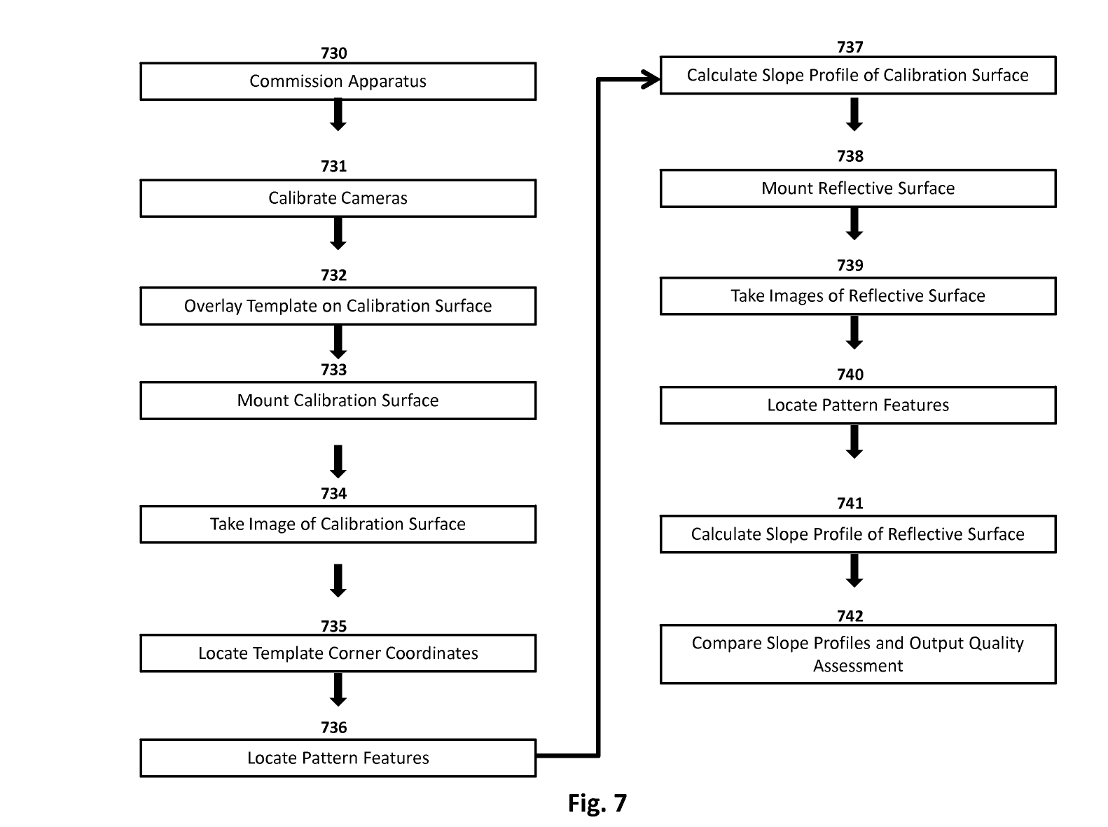

FIGS. 7-10 outline the method steps for assessing reflector quality according to alternative embodiments of the present invention. The following steps can be performed manually by users of the deflectometry system or automated using robotic systems, sensors, and processors. The processing time for a single evaluation by the image processing and quality assessment software shall total less than 10 seconds in aggregate.

FIG. 7 is a detailed flowchart depiction of a method (730) for assessing the quality of a reflector using a first embodiment of the present invention, wherein the method comprises the following steps:
1) Setup the automated deflectometry system according to the embodiment depicted in FIG. 1, wherein the calibration surface has a known surface quality and has a larger mirror area than the mirror area of the reflective surface to-be-measured,
2) Commission the holding fixture and target screen to be parallel to each other at a predetermined distance apart,
3) Calibrate the digital cameras,
4) Overlay a template having the same dimensions as the reflective surface onto the calibration surface,
5) Mount the calibration surface onto the holding fixture,
6) Take an image of the calibration surface with each camera,
7) Determine the coordinates of the corners of the template using the image processing software,
8) Locate the features of the known pattern in the images of the calibration surface using the image processing software,
9) Calculate the slope profile of the calibration surface,
10) Replace the calibration surface on the holding fixture with a reflective surface to-be-measured,
11) Take an image of the reflective surface with each camera,
12) Locate the features of the known pattern in the images of the reflective surface using the image processing software,
13) Calculate the slope profile of the reflective surface, 14) Compare the slope profile of the calibration surface with the slope profile of the reflective surface, and
15) Assign a grade to the reflective surface according to a quality metric and output the grade to a user interface.

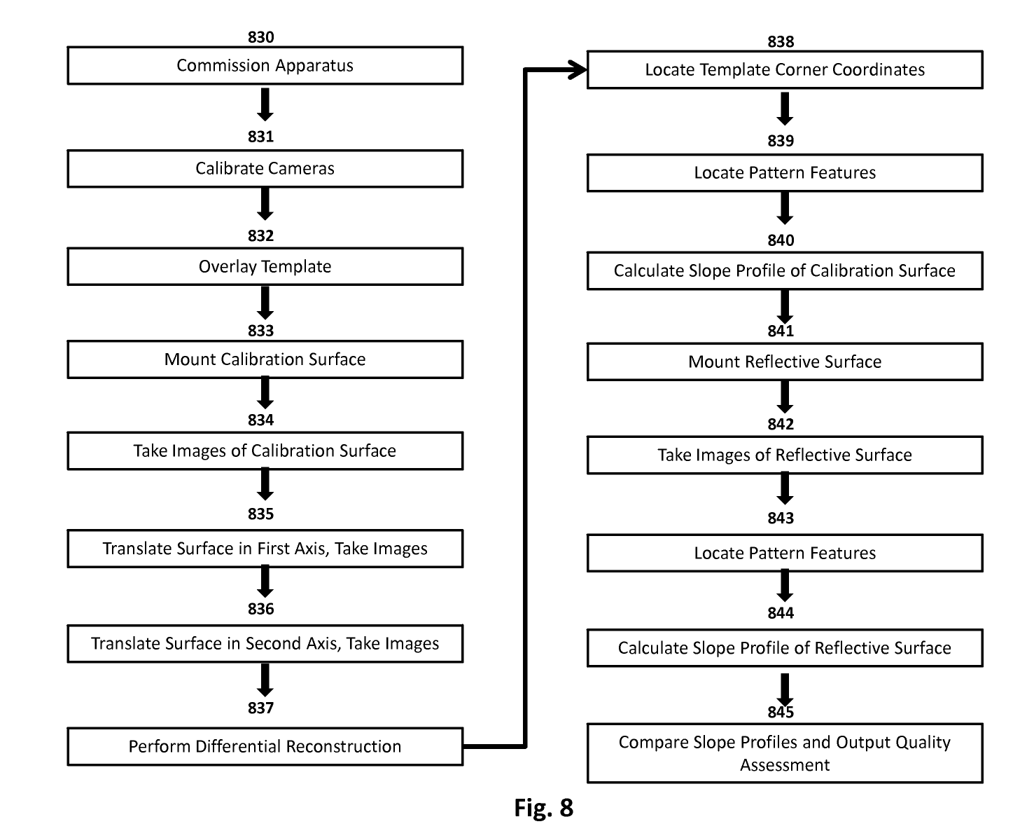

FIG. 8 is a detailed flowchart depiction of a method (830) for assessing the quality of a reflector using a second embodiment of the present invention, wherein the method comprises the following steps:
1) Setup the automated deflectometry system according to the embodiment depicted in FIG. 2, wherein the calibration surface has an unknown surface quality and has a larger mirror area than the reflective surface to-be-measured,
2) Commission the holding fixture and target screen to be parallel to each other at a predetermined distance apart,
3) Calibrate the digital cameras,
4) Overlay a template having the same dimensions as the reflective surface onto the calibration surface,
5) Mount the calibration surface onto the holding fixture,
6) Take a first image of the calibration surface with each camera,
7) Translate the calibration surface along a first axis in the plane parallel to the target screen face and take a second image of the calibration surface with each camera,
8) Translate the calibration surface along a second axis in the plane parallel to the target screen face and take a third image of the calibration surface with each camera,
9) Perform a differential reconstruction of the mirror surface using the first, second, and third images and produce a reconstructed image,
10) Determine the coordinates of the corners of the template using the image processing software,
11) Locate the features of the known pattern in the reconstructed image of the calibration surface using the image processing software,
12) Calculate the slope profile of the calibration surface,
13) Replace the calibration surface on the holding fixture with a reflective surface,
14) Take an image of the reflective surface with each camera,
15) Locate the features of the known pattern in the images of the reflective surface using the image processing software,
16) Calculate the slope profile of the reflective surface,
17) Compare the slope profile of the reconstructed image of the calibration surface with the slope profile of the reflective surface, and
18) Assign a grade to the reflective surface according to a quality metric and output the grade to a user interface.

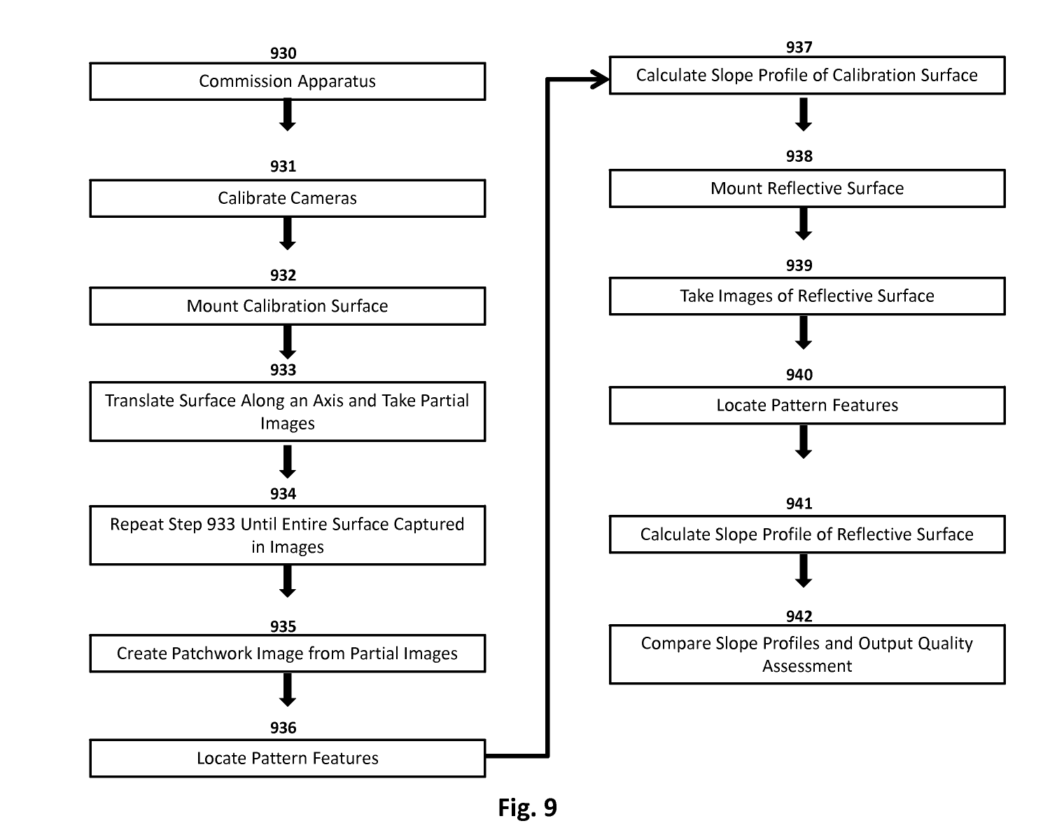

FIG. 9 is a detailed flowchart depiction of a method (930) of assessing the quality of a reflector using a third embodiment of the present invention, wherein the method comprises the following steps:
1) Setup the automated deflectometry system according to the embodiment depicted in FIG. 2, wherein the calibration surface has a known surface quality and has a mirror area substantially less than the reflective surface to-be-measured,
2) Commission the holding fixture and target screen to be parallel to each other and set a predetermined distance apart.
3) Calibrate the digital cameras,
4) Mount the calibration surface onto the holding fixture,
5) Translate the calibration surface along at least one axis in the plane parallel to the target screen face and take an image of the calibration surface with each camera,
6) Repeat Step 5 until the entirety of the known pattern on the target screen has been captured in reflected images,
7) Using the image processing software, stitch the plurality of images of the calibration surface at different positions into a patchwork image,
8) Locate the features of the known pattern in the patchwork image using the image processing software,
9) Calculate the slope profile of the calibration surface,
10) Replace the calibration surface on the holding fixture with a reflective surface,
11) Take an image of the reflective surface with each camera,
12) Locate the features of the known pattern in the images of the reflective surface using the image processing software,
13) Calculate the slope profile of the reflective surface,
14) Compare the slope profile of the patchwork image of the calibration surface with the slope profile of the reflective surface, and
15) Assign a grade to the reflective surface according to a quality metric and output the grade to a user interface.

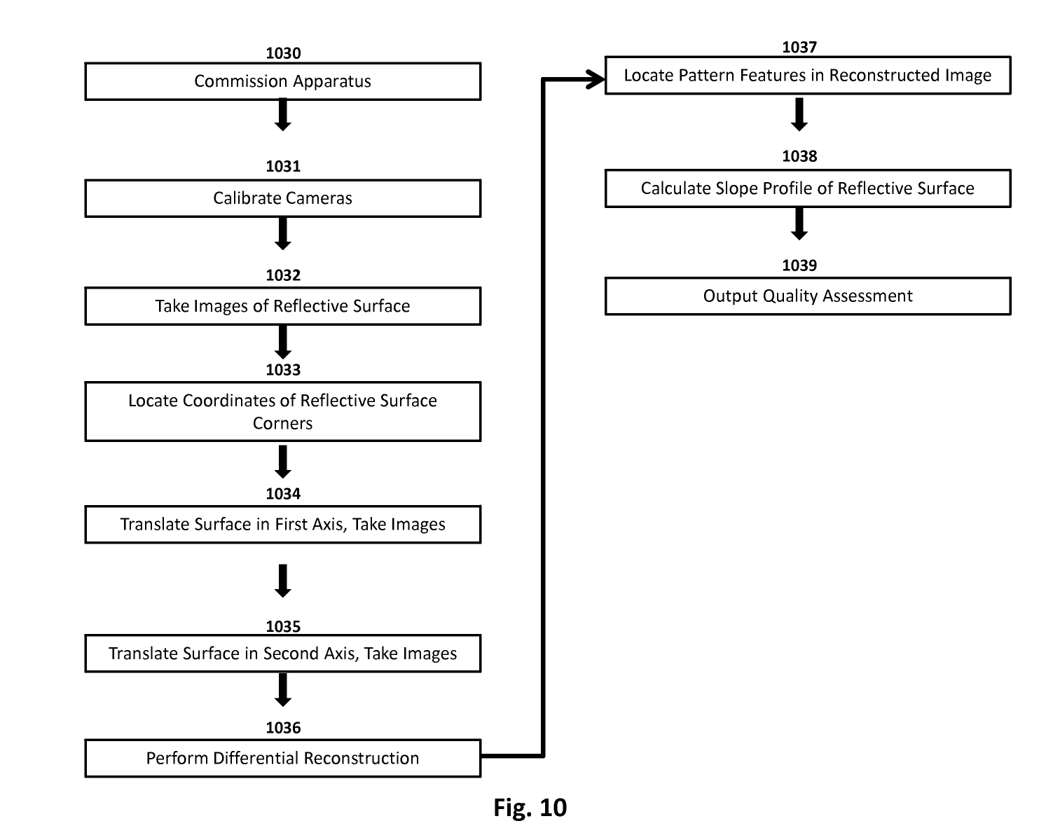

FIG. 10 is a detailed flowchart depiction of a method (1030) of assessing the quality of a reflector using a fourth embodiment of the present invention, wherein the method comprises the following steps:
1) Setup the automated deflectometry system according to the embodiment depicted in FIG. 2, wherein the reflective surface mounted to the holding fixture is the reflective surface to-be-measured,
2) Commission the holding fixture and target screen to be parallel to each other and set a predetermined distance apart,
3) Calibrate the digital cameras,
4) Take a first image of the reflective surface with each camera,
5) Determine the coordinates of the corners of the reflective surface using the image processing software,
6) Translate the reflective surface along a first axis in the plane parallel to the target screen face and take a second image of the reflective surface with each camera,
7) Translate the reflective surface along a second axis in the plane parallel to the target screen face and take a third image of the reflective surface with each camera,
8) Perform a differential reconstruction of the mirror surface using the first, second, and third images and produce a reconstructed image,
9) Locate the features of the known pattern in the reconstructed image of the reflective surface,
10) Calculate the slope profile of the reflective surface, and
11) Assign a grade to the reflective surface according to a quality metric and output the grade to a user interface.

The step of commissioning the holding fixture and target screen to be parallel to each other can include the steps of taking a measurement of the spacing between the target screen and the holding fixture at multiple points along their perimeters. This can be done, for example, using measuring tape, by referring to makes premade in the floor, by using a rangefinder laser, or another suitable technique. For example, a 5-directional laser can be positioned in the middle of the target screen and fired at the calibration or reflective surface to-be-measured. The reflector can be aligned by actuating or shifting the holding fixture such that the laser hits a marked spot on the reflective surface and reflects back to the position of the laser in the target screen. Rotational alignment of the laser can be achieved using horizontal lasers back-reflected from the edges of the target screen.

The step of calibrating the cameras can include the steps of focusing the cameras, utilizing the zoom feature, and taking an image of the target screen with each camera and processing the images using the image processing software to ascertain image quality. The cameras can be calibrated using the target screen or an alternate target screen having a different pattern. The step of actuating the calibration surface or reflective surface to-be-measured can comprise the steps of actuating the holding fixture arm to move the mirror along one or more axes in the plane parallel to the target screen.

The following details the technique by which a differential reconstruction of images is conducted. The first step is to take a first image of the reflective surface using the cameras, wherein the reflective surface can be a calibration surface or a reflective surface to-be-measured. Next, the reflective surface is translated a predetermined distance along a first axis, the first axis comprising one of either a horizontal or vertical axis, at which point a second image is taken of the reflective or calibration surface by each camera. The reflective surface can be translated, for example, by actuating the robotic arm of the holding fixture. Next, the reflective surface is translated a predetermined distance along a second axis, the second axis comprising the other of the horizontal and vertical axis (the first and second axes being orthogonal to each other), at which point a third image is taken of the reflective or calibration surface by each camera. The image processing software then compares the first and second images and finds the differences between them. Differences can include, for example, deviation in the coordinates of pattern features, as measured on a per-pixel basis (see pattern detection and coordinate assignment procedures below). These differences define the derivative of the horizontal and vertical slope error with respect to the first axis. The image processing software then compares the first and third images and finds the difference between them. Similarly, these differences define the derivative of the horizontal and vertical slope error with respect to the second axis. These two derivative quantities represent a gradient field, one that happens to be non-integrable. The slope error in a given axis, and therefore the components comprising the slope map, can be found by integrating these partial derivatives by, for example, a Poisson solver.

The following details the technique by which the features and corners of the reflective surface or of the template overlaid on the calibration surface are identified by the image processing software. Note that, where possible, the following steps are parallelizable; if the image processing software can perform multiple tasks, detection methods, or coordinate assignments simultaneously it will do so. For a known pattern exhibiting a checkerboard design, the first step is to determine the location of all boundaries between checkers, as it is the boundaries themselves that are used as features for image comparative purposes. This is accomplished by estimating the dimensions (height and width) of a single rectangular checker using, for example a pattern-matching algorithm or a fast Fourier transform (FFT) phase correlation. Next the processing software utilizes a feature detector to extract the likely positions of the light and dark checkers in the image. The feature detector scans each pixel, and for each pixel it identifies the pixels that appear one checker space ahead and one checker space behind in both axes (X and Y, row and column). The “checker space” is the previously determined estimated dimension of the checker in the corresponding axial direction. If the scanned pixel is brighter (or darker) than the pixels in all four neighboring checkers in both axes, then it is a white (or black) checker. Now that the colors of the pixels are defined, the edges of a checker can be represented as the boundary where the pixels transition from one color to the other (from dark-to-light or light-to-dark). The edge detection method can comprise, for example, a Canny edge detection operator that distinguishes between edge and “non-edge” pixels. The processing software then applies the edge detection operator in both axes and, using a binary threshold, ascribes a value to every pixel based on its edge or non-edge status. Then the processor detects connected regions of pixels having the same values and groups them into similarly connected regions using a blob detection method to define the entire checkerboard.

After the locations of all checker corners in the image have been detected, the next step is to assign each corner point a coordinate; coordinates are first defined relative to the entire grid, and are then associated with real world positions. The straightforward method is to divide the image into checker-sized spaces and assign coordinates to the corners based on the checker dimensions (rounding when necessary). However, because the reflected image of the checkerboard grid may be greatly distorted depending on the slope of the reflective surface or the alignment of the target and/or holding fixture, this approach may not be sufficiently robust. Instead the processing software breaks the set of points (the grid corners) into smaller grid subsets and assigns coordinates to the points in each subset. Then the full grid is re-created by overlapping all of the subsets onto each other and consolidating overlapping points to match neighboring sub-grids. To calculate the world coordinates, the image processer first locates the region expected to contain the non-repeating feature and scans each checker (as defined by the edge pixels above) to find the checker exhibiting the darkest hue. With the position of the non-repeating feature (the “darkest checker” in the previous scan) now identified, the processor can shift the previously assigned grid coordinates to account for any error. Finally the grid coordinates are converted to world coordinates using the approximate geometry of the measured system, such as the dimensions of the reflective surface, the position of the reflective surface relative to the cameras, the boundaries of the holding fixture, or other defined distances and locations.

With corner locations and the checker board grid having now been ascribed coordinates, the last step to fully mapping the reflective surface in the image is to identify the boundaries of the mirror. This step is performed by identifying, using the image processing software, the transition between the checkers and a dark border. To create this contrast, the holding fixture can incorporate a flat dark background that extends beyond the edge of the mirror as seen by the cameras. The dark background can comprise black material such as a cloth or sheet attached to the holding fixture and set around the perimeter of the reflective surface. With this addition the image of the reflective surface comprises the distorted known pattern surrounded by a black border. To estimate the mirror boundaries, the processing software performs a blob-detection of the image to discern regions of the image made up of pixels exhibiting similar brightness and then eliminating the regions, or “blobs” that are smaller than a predetermined fractional threshold of the expected checker size. The software then calculates the convex hull of the remaining blobs, which involves drawing the smallest possible polygon around the entire set of points. This polygon is then fit to the expected rectangular shape of the reflective surface. The result is a set of coordinates that define the edges of the mirror and encompass the checkerboard pattern. As an alternative, if only part of the mirror is outlined by the black border, such as the case in which only part of the background is blocked by the holding fixture having the dark surface, only that corresponding part of the image is fit to the shape of the mirror.

The following details the technique by which the slope of the mirror is calculated from perturbations in locations of the known pattern features between the images of the calibration surface and a reference surface or reference image. In prior steps, the image processing software determines a mapping between pixels in the image and coordinates on the reflective surface and a mapping between the location of pixels in the reflected image and the coordinates, or physical location, of the reflected light ray onto the target screen having the known pattern. These two transformations can be combined to yield a mapping from the physical position of the reflective surface to the destination of reflected light on the known pattern. Calculating the destination of reflected light on the target is highly sensitive to the identification of the mirror boundary, and so the same transformation between reflective surface coordinates and pixels is used for the images taken from all cameras. This provides the system with additional robustness in the event that the mirror surface is perturbed or moved during the test. While such a disturbance does create error in the location on the mirror where the light deflections actually occur, the magnitude of the deflection values themselves are unaffected, and it is these magnitudes which have a much larger impact on the ultimate performance assessment of the reflector.

Next, the image processing software compares the destination of reflected light from the image of the measured reflective surface to the corresponding destinations from the image of the calibration surface and calculates the discrepancies between these destinations in real world-coordinates. These discrepancies and the measured system geometry are used to calculate the deflection, an indicator of the mirror “slope”, at a point on the reflective surface. Each digital camera of the automated deflectometry system supplies an individual image from which the deflection of light at each point on the reflective surface can be estimated. If the elements of the deflectometry system have been aligned properly such that their geometry is as expected, these estimates should be equivalent. If the images from the multiple cameras produce differing results, it is likely that the calibration surface and the target were properly positioned parallel to each other. The software can correct for being “out of plane” by perturbing the image processing model to adjust a “plane factor” until the output from the multiple cameras register similar values for the measured deflections. Alternatively it is also possible to conduct the deflectometry measurements using a subset of the total digital cameras, including only one camera.

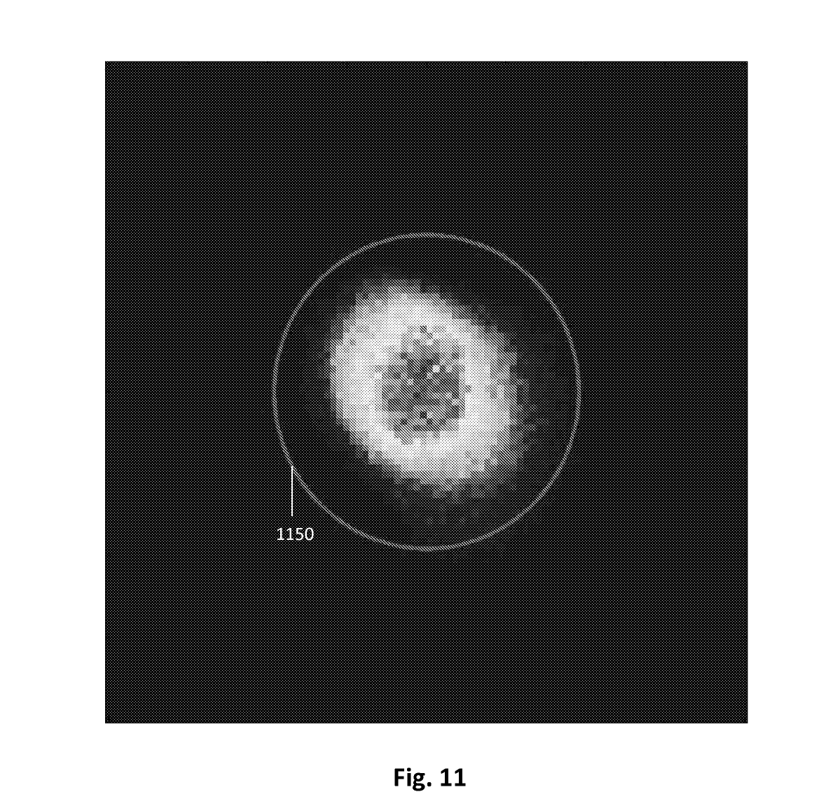

FIG. 11 is a depiction of simulated flux from a reflector onto a receiver. This simulation can be generated by the post processing software of the reflector quality assessment system. It can be done by solving a ray-tracing calculation using, as an input, the true slope profile of a reflective surface. This simulation is conducted by placing the reflector in representative positions throughout a virtual heliostat field of a concentrated solar power (CSP) plant and evaluating its performance over multiple representative points in time. For each simulated configuration, the calculation simulates the size and direction of a beam of sunlight reflected from the measured reflective surface onto a receiver and evaluates the beam's “tightness”, or the area within which the reflected solar flux is contained and the accuracy with which the beam has impacted a desired region of the receiver. The aggregation of these flux simulations is used to derive a characteristic metric. The characteristic metric is defined by prior correlation of its value to the spillage of light, where spillage is defined as the amount of solar flux reflected from the reflective surface or heliostat that misses or lies outside a desired region 1150 of the reflector. The allowable amount of flux spillage varies depending on the layout of a CSP heliostat field, and so the characteristic metric can be tailored to specific projects or world locations. This allows for the reflector quality assessment system to accommodate different requirements and conditions.

A user interface displays the results of the aforementioned calculations to an operator. For example, the user interface can display a floating point value or measure signifying the quality of the reflector. This floating point value on the display can be color coded for ease of interpretation. The user interface can also display a 3D rendering of the reflector shape having exaggerated distortions based on the slope profile. The operator can use the data and the visual depictions to make informed decisions about the quality control process for reflective surface assembly. Alternatively, the process can be automated to compare the result of the ray-tracing calculation to a predetermined metric and provide an immediate assessment of the reflector quality.

Various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further it is intended that the scope of the present invention herein disclosed by way of examples should not be limited by the particular disclosed embodiments described above.

We claim:

1. An automated deflectometry system for assessing the quality of a reflector, the deflectometry system comprising:
a target screen having a known pattern and at least one aperture;
a reflector having a reflective surface mounted to a frame;
a holding fixture capable of interfacing with the frame to hold the reflector parallel to the target screen;
at least one digital camera having a lens positioned to see through at least one aperture;
an image processor connected to the at least one digital camera, wherein the image processor takes as an input images taken by the digital camera and outputs the slope profile of the reflective surface.

2. The deflectometry system of claim 1, wherein the reflective surface is a heliostat reflector.

3. The deflectometry system of claim 1, wherein the reflective surface is a calibration surface.

4. The deflectometry system of claim 3, further comprising a template overlaid on the calibration surface.

5. The deflectometry system of claim 1, wherein the holding fixture is a robot having an arm with multiple points of articulation.

6. The deflectometry system of claim 1, wherein the known pattern is a sequence of repeated shapes.

7. The deflectometry system of claim 6, wherein the known pattern is a checkerboard or grid of alternating colored or black and white squares.

8. The deflectometry system of claim 6, wherein the known pattern is a grid of lines having variable thickness and spacing.

9. The deflectometry system of claim 7, wherein the known pattern further comprises at least one feature having a different color than the colors found in the checkerboard or grid squares.

10. The deflectometry system of claim 1, wherein the holding fixture further comprises a black sheet set behind the periphery of the reflective surface.

11. A method of assessing the quality of a reflective surface, which comprises the steps of:
(a) Commissioning a deflectometry apparatus comprising a target screen having at least one aperture, a reflector having a reflective surface mounted to a frame, a calibration surface, a holding fixture that interfaces with the frame to hold the reflector parallel to the target screen, and at least one digital camera positioned to see through the at least one aperture and connected to an image processor having a graphical user display;
(b) Configuring the holding fixture and target screen to be parallel to each other at a predetermined distance apart,
(c) Calibrating the digital cameras,
(d) Overlaying a template having the same dimensions as the reflective surface onto the calibration surface,
(e) Mounting the calibration surface onto the holding fixture,
(f) Taking an image of the calibration surface with each camera,
(g) Determining the coordinates of the corners of the template using the image processor,
(h) Locating the features of the known pattern in the images of the calibration surface using the image processor,
(i) Calculating the slope profile of the calibration surface,
(j) Replacing the calibration surface on the holding fixture with a reflective surface,
(k) Taking an image of the reflective surface with each camera,
(l) Locating the features of the known pattern in the images of the reflective surface using the image processing software,
(m) Calculating the slope profile of the reflective surface,
(n) Comparing the slope profile of the calibration surface with the slope profile of the reflective surface, and
(o) Assigning a grade to the reflective surface according to a quality metric and outputting the grade to a user interface.

12. A method of assessing the quality of a reflective surface, which comprises the steps of:
(a) Commissioning a deflectometry apparatus comprising a target screen having at least one aperture, a reflector having a reflective surface mounted to a frame, a calibration surface, a holding fixture that interfaces with the frame to hold the reflector parallel to the target screen, and at least one digital camera positioned to see through the at least one aperture and connected to an image processor having a graphical user display;
(b) Configuring the holding fixture and target screen to be parallel to each other at a predetermined distance apart,
(c) Calibrating the digital cameras,
(d) Overlaying a template having the same dimensions as the reflective surface onto the calibration surface,
(e) Mounting the calibration surface onto the holding fixture,
(f) Taking a first image of the calibration surface with each camera,
(g) Translating the calibration surface along a first axis in the plane parallel to the target screen face and taking a second image of the calibration surface with each camera,
(h) Translating the calibration surface along a second axis in the plane parallel to the target screen face and taking a third image of the calibration surface with each camera,
(i) Performing a differential reconstruction of the mirror surface using the first, second, and third images and producing a reconstructed image,
(j) Determining the coordinates of the corners of the template using the image processor,
(k) Locating the features of the known pattern in the reconstructed image using the image processor,
(l) Calculating the slope profile of the calibration surface,
(m) Replacing the calibration surface on the holding fixture with a reflective surface,
(n) Taking an image of the reflective surface with each camera,
(o) Locating the features of the known pattern in the images of the reflective surface using the image processing software,
(p) Calculating the slope profile of the reflective surface,
(q) Comparing the slope profile of the reconstructed image of the calibration surface with the slope profile of the reflective surface, and
(r) Assigning a grade to the reflective surface according to a quality metric and outputting the grade to a user interface.

13. A method of assessing the quality of a reflective surface, which comprises the steps of:
(a) Commissioning a deflectometry apparatus comprising a target screen having at least one aperture, a reflector having a reflective surface mounted to a frame, a holding fixture that interfaces with the frame to hold the reflector parallel to the target screen, and at least one digital camera positioned to see through the at least one aperture and connected to an image processor having a graphical user display;
(a) Configuring the holding fixture and target screen to be parallel to each other at a predetermined distance apart,
(b) Calibrating the digital cameras,
(c) Taking a first image of the reflective surface with each camera,
(d) Determining the coordinates of the corners of the reflective surface using the image processing software,
(e) Translating the reflective surface along a first axis in the plane parallel to the target screen face and taking a second image of the reflective surface with each camera,
(f) Translating the reflective surface along a second axis in the plane parallel to the target screen face and taking a third image of the reflective surface with each camera,
(g) Performing a differential reconstruction of the mirror surface using the first, second, and third images and producing a reconstructed image,
(h) Locating the features of the known pattern in the reconstructed image of the reflective surface,
(i) Calculating the slope profile of the reflective surface, and
(j) Assigning a grade to the reflective surface according to a quality metric and output the grade to a user interface.

14. The method of assessing the quality of a reflective surface of claim 11, 12, or 13, wherein the step of assigning a grade to the reflective surface comprises at least one of the following steps:
(a) simulating the flux reflected from a heliostat having the reflective surface onto the receiver of a concentrating power plant;
(b) calculating the RMS slope error of the reflective surface.

15. The method of assessing the quality of a reflective surface of claim 14, wherein the step of simulating reflected flux can comprise a ray tracing calculation.

16. The method of assessing the quality of a reflective surface of claim 14, wherein the step of assigning a grade to the reflective surface shall be performed in less than 10 seconds.

17. The method of assessing the quality of a reflective surface of claim 11, 12, or 13, wherein the known pattern is a checkerboard or grid of alternating colored or black and white squares.

18. The method of assessing the quality of a reflective surface of claim 12, wherein the calibration surface has a smaller surface area than the reflective surface.

19. The method of assessing the quality of a reflective surface of claim 12, wherein the calibration surface has a larger surface area than the reflective surface.
